(19) United States
(12) Patent Application Publication
(10) Pub. No.: US 2026/0009958 A1
(43) Pub. Date: Jan. 8, 2026

(54) Optical Fiber Cable With Stranded Core

(71) Applicant: STERLITE TECHNOLOGIES LIMITED, Gurugram (IN)

(72) Inventors: Sravan Kumar Peraka, Gurugram (IN); Prasannakumar Pardeshi, Gurugram (IN)

(21) Appl. No.: 19/260,145

(22) Filed: Jul. 3, 2025

(30) Foreign Application Priority Data
Jul. 4, 2024 (IN) 202411041200

(51) Int. Cl. G02B 6/44

(52) U.S. Cl. CPC G02B 6/441

(57) ABSTRACT

The present disclosure provides an optical fiber cable (10) comprising: a core (12); and a sheath (14) surrounding the core (12). Particularly, the core (12) comprising a plurality of optical fiber bundles (16₁, 16₂, 16₃, . . . ) present in at least two concentric layers (18₁, 18₂, . . . ). Further, the plurality of optical fiber bundles (16₁, 16₂, 16₃, . . . ) are held together by one or more core-binding elements (20₁, 20₂, . . . ) applied only to an outermost surface (22) of the core (12).

### CROSS-REFERENCE TO RELATED APPLICATIONS

The present application claims the benefit of Indian Application No. IN202411051200 titled “OPTICAL FIBER CABLE WITH STRANDED CORE” filed by the applicant on Jul. 4, 2024, which is incorporated herein by reference in its entirety.

### FIELD OF THE INVENTION

Embodiments of the present invention relate to the field of wireless communication networks of optical fibres, and in particular, relates to the optical fiber cable with a stranded cable core and a method for manufacturing the optical fiber cable with stranded cable and the optical fibre produced thereof.

### DESCRIPTION OF THE RELATED ART

An optical fiber network finds its presence in every region across the globe. The optical fiber network supports world-wide communication systems and ensures uninterrupted services related to voice calls, internet and the like. Optical fiber cables are the foundation for the optical fiber networks and link one optical fiber network to another optical fiber network. The optical fiber cables comprise optical transmission elements, i.e., optical fibers, that are responsible for linking the optical fiber networks.

Fiber optic communication systems deliver high bandwidth communication capabilities to customers. Optical fiber connectors are an important part of most fiber optic communication systems that allow two optical fibers to be quickly, optically connected without requiring a splice. Further, the fiber optic connectors can be used to optically interconnect two lengths of optical fiber. Also, it can be used to interconnect lengths of optical fiber to passive and active equipment.

There is an ever-increasing demand for high-speed or high-bandwidth communication channels for delivering high-speed data and video services. To meet this demand, telecommunications service providers are developing networks (sometimes referred to as outside plant networks) that extend the higher bandwidth of fiber optic components all the way to the end-user businesses and homes (referred to as premises).

Conventional optical fiber cable comprises a core and a sheath surrounding the core. The core generally comprises a plurality of optical fiber bundles grouped and twisted to form a first layer and bound together using a binding element. Thereafter, a remainder of the plurality of optical fiber bundles are placed around the first layer to form a second layer which is concentric to the first layer. The second layer is then twisted and bound together using an additional binding element. Further, the plurality of optical fiber bundles in the first layer are twisted in one direction and then the other (forming an “S” and “Z” pattern). Likewise, the plurality of optical fiber bundles of the second layer are twisted in one direction and then the other (forming an “S” and “Z” pattern) to form the core.

Disadvantages in the conventional construction of the optical fiber cable includes a low fiber density, typically in the range of 40 to 60%, an increase in the weight of the cable and attenuation in the optical fibers contributed by presence of excessive binding element and increase in a cost of the cable contributed by presence of excessive binding element.

Further, the optical fiber cable having the aforesaid construction may have the possibility that the lay length of the first layer (lay length of the first layer being the distance along the cable over which the optical fiber bundles of the first layer makes one complete turnaround the cable's axis) mismatches the lay length of the second layer (lay length of the second layer being the distance along the cable over which the optical fiber bundles of the second layer makes one complete turnaround the cable's axis). This mismatch in lay length of the first layer and lay length of the second layer results in higher attenuation and higher degradation of optical properties of the fiber.

Additionally, Conventional cables, cable assemblies, fiber optic hardware and other network components typically define structure that accommodates, and is in part, limited by the physical characteristics of the space. In other words, it is oftentimes the case that the physical and performance limitations of the assemblies, hardware, routing, etc. partly define assembly structure and processes associated with designing and installing optical networks. For instance, the optical network designer must design the optical network to maintain optical performance with an acceptable budget loss for the same.

Accordingly, to overcome the disadvantages of the prior arts, there is a need for a technical solution that overcomes the above-stated limitations in the prior arts. The present invention provides an optical fiber cable with stranded cable and a method of manufacturing the same.

### SUMMARY OF THE INVENTION

Embodiments of the present invention relates to an optical fiber cable comprising a core and a sheath surrounding the core. In particular, the core comprises a plurality of optical fiber bundles present in at least two concentric layers. Moreover, the plurality of optical fiber bundles are held together by one or more core-binding elements. Further, the one or more core-binding elements are helically applied and the one or more core-binding elements are helically applied only to the outermost surface of the core.

In accordance with an embodiment of the invention, the core-binding elements comprise a water swellable yarn. In particular, the core-binding elements comprise a single ended binder yarn or a dual ended binder yarn. Further, the core-binding elements are at least in partial contact with the fibers of the outermost surface of the core.

In accordance with an embodiment of the invention, the optical fiber bundles in at least two concentric layers are twisted in a first direction and then in a second direction opposite to the first direction (forming an “S” and “Z” pattern) with substantially the same lay length.

In accordance with an embodiment of the invention, a ratio of lay length of stranding of the core to diameter of the core is in the range of 25 to 100.

In accordance with an embodiment of the invention, a ratio of lay length (L1) of the core (12) to the lay length of at least one core-binding element is in the range of 4 to 12.

In accordance with an embodiment of the invention, the at least two concentric layers are twisted so as to be substantially in-phase with each other.

In accordance with an embodiment of the invention, the optical fiber in the bundles are intermittently bonded ribbon fibers. In particular, each bundle comprises a plurality of intermittently bonded ribbons bound by one or more bundle binder yarns.

In accordance with an embodiment of the invention, change in attenuation of one or more optical fiber with the optical fiber cable bent at 20 times outer diameter of the optical fiber cable is less than 0.05 dB/km measured at 1550 nanometer wavelength.

In accordance with an embodiment of the invention, the optical fiber cable has a filling coefficient of greater than 60% with respect to internal diameter of the optical fiber cable.

Another embodiment of the present invention relates to a method of manufacturing an optical fiber cable comprising steps of: providing a core comprising a plurality of optical fiber bundles present in at least two concentric layers, helically applying one or more core-binding elements only on an outermost surface of the core so as to hold the plurality of optical fiber bundles and extruding a sheath so as to surround the core having the one or more core-binding elements applied thereto.

The foregoing objectives of the present invention are attained by employing an optical fiber cable the optical fiber cable with a filling coefficient of greater than 60% with respect to internal diameter of the optical fiber cable, reduced weight and reduced cost due to absence of binding element to bind the plurality of optical fiber bundles in at least one inner layer of the at least two concentric layers.

### BRIEF DESCRIPTION OF DRAWINGS

To describe the technical solutions in the embodiments of the present invention or in the prior art more clearly, the following briefly describes the accompanying drawings required for describing the embodiments or the prior art. Apparently, the accompanying drawings in the following description merely show some embodiments of the present invention, and a person of ordinary skill in the art can derive other implementations from these accompanying drawings without creative efforts. All of the embodiments or the implementations shall fall within the protection scope of the present invention.

FIG. 1 is a pictorial snapshot illustrating a cross-sectional view of the optical fiber cable constructed in accordance with an embodiment of the invention;

FIG. 2 is a pictorial snapshot illustrating a cross-sectional view of the optical fiber cable constructed in accordance with another embodiment of the invention;

FIG. 3 is a pictorial snapshot illustrating an optical fiber bundle in accordance with an embodiment of the invention; and

FIG. 4 is a pictorial snapshot illustrating cross-sectional of the core of the optical fiber cable constructed in accordance with another embodiment of the invention.

The optical fiber cable is illustrated in the accompanying drawings, which like reference letters indicate corresponding parts in the various figures. It should be noted that the accompanying figure is intended to present illustrations of exemplary embodiments of the present invention. This figure is not intended to limit the scope of the present invention. It should also be noted that the accompanying figure is not necessarily drawn to scale.

### DESCRIPTION OF EMBODIMENTS

Those skilled in the art will be aware that the present invention is subject to variations and modifications other than those specifically described. It is to be understood that the present invention includes all such variations and modifications. The invention also includes all such steps, features, compositions and compounds referred to or indicated in this specification, individually or collectively, and any and all combinations of any or more of such steps or features.

### Definitions

For convenience, before further description of the present invention, certain terms employed in the specification, and examples are collected here. These definitions should be read in the light of the remainder of the invention and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”. Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The following brief definition of terms shall apply throughout the present invention:

Optical fiber cable includes a plurality of fibers and carries information in the form of data between two places using light technology. The optical fiber cable is a cable used for carrying light over long distances. Furthermore, the optical fiber cable may simply be used to transmit optical signals which may carry sensor data or communication data.

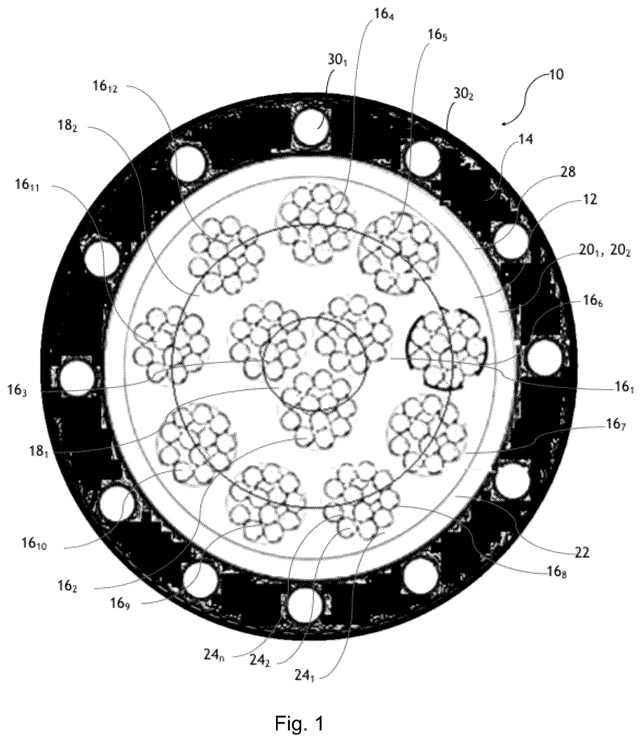

FIG. 1 is a pictorial snapshot illustrating a cross-sectional view of the optical fiber cable constructed in accordance with an embodiment of the invention;

The optical fiber cable (10) comprises a core (12); and a sheath (14) surrounding the core (12). In particular, the core (12) comprises a plurality of optical fiber bundles (16₁, 16₂, 16₃, . . . ) present in at least two concentric layers (18₁, 18₂). Moreover, the plurality of optical fiber bundles (16₁, 16₂, 16₃, . . . ) are held together by one or more core-binding elements (20₁, 20₂, 20₃, . . . ). Further, the one or more core-binding elements (20₁, 20₂, 20₃, . . . ) are applied only to the outermost surface (22) of the core (12).

In accordance with an embodiment of the present invention, the optical fiber bundles (16₁, 16₂, 16₃, . . . ) in each of the at least two concentric layers (18₁, 18₂) are twisted in a first direction (D1) and then in second direction (D2) opposite to the first direction, forming an “S” and “Z” pattern. In particular, the optical fiber bundles (16₁, 16₂, 16₃, . . . ) in at least two concentric layers (18₁, 18₂) have substantially the same lay length (L1). By way of a non-limiting example, a ratio of the lay length (L1) of the core (12) to diameter of the core (12) is in the range of 25 to 100. Moreover, the at least two concentric layers (18₁, 18₂) are twisted so as to be substantially in-phase with each other. If the optical fiber bundles (16₁, 16₂, 16₃, . . . ) within the at least two concentric layers (18₁, 18₂) do not possess substantially identical lay lengths or are not synchronized in phase, the binding of the two concentric layers solely using core-binding elements (20₁, 20₂, 20₃, . . . ) on the outermost layer may not give structural integrity to the core.

In accordance with an embodiment of the present invention, when the ratio of lay length (L1) of the core (12) to diameter of the core (12) is below 25, the lay of the optical fiber bundles will be small and will result in bulges in the stranded layers and also unnecessary extra fiber length inside the cable. There will be a higher amount of stress generation on optical fibers due to lack of free space and more pressure points. Further, manufacturing speed gets reduced.

While several possible embodiments of the invention have been described above and illustrated in some cases, it should be interpreted and understood as to have been presented only by way of illustration and example, but not by limitation. It is believed that when the ratio is above 100, stress distribution among the fibers will not be uniform and hence attenuation on the lower side of the core will experience compressive strain and ones on the top will have tensile strain.

In accordance with an embodiment of the present invention, the one or more core-binding elements (20₁, 20₂, 20₃, . . . ) are helically applied. In particular, a ratio of lay length (L1) of the core (12) to lay length (L2) of at least one core-binding element (20₁, 20₂, 20₃, . . . ) is in the range of 4 to 12. Moreover, when the ratio of lay length (L1) of the core (12) to lay length (L2) of the at least one core-binding elements (20₁, 20₂, 20₃, . . . ) is below 4, either SZ lay length of the bundles would be small or binding element lay length would be large. Small SZ lay will result in bulges in the stranded layers and also unnecessary extra fiber length inside the cable. Further, the manufacturing speed also gets reduced.

In an embodiment of the present invention, the binding element lay is large, the binding may not be proper to hold the stranded bundles.

While several possible embodiments of the invention have been described above and illustrated in some cases, it should be interpreted and understood as to have been presented only by way of illustration and example, but not by limitation. It is believed that when the ratio is above 12, either SZ lay would be large or binding element lay would be small. With large SZ lay, ERL will not be sufficient, and optical attenuations may increase. Further, smaller binding element lay may impart stresses on the fiber bundles and the optical attenuations may increase.

In accordance with an embodiment of the present invention, one or more core-binding elements (20₁, 20₂, 20₃, . . . ) comprises a water swellable yarn. In particular, the one or more core-binding elements (20₁, 20₂, 20₃, . . . ) comprises a single ended binder yarn or a dual ended binder yarn. Further, the single ended binder yarn is intended to include yarn that has a single end on both sides and comprising a plurality of threads. And, the dual ended binder yarn is intended to include yarn that has two ends on both sides and each comprising a plurality of threads.

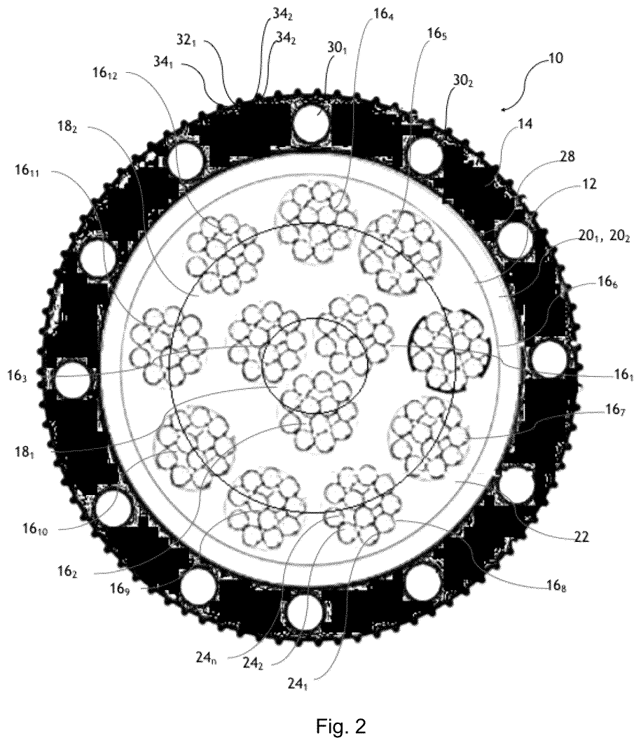

FIG. 2 is a pictorial snapshot illustrating a cross-sectional view of the optical fiber cable constructed in accordance with another embodiment of the invention. The optical fiber cable (10) may be specifically adapted for installing in duct using compressed air (also referred to commonly as air blowing optical fiber cable installation technique). In particular, the air blowing optical fiber cable installation technique involves propelling the optical fiber cable through a duct by the force of the air, reducing the physical strain on the optical fiber cable and minimizing the risk of damage during installation. Thus, it enhances the ease of installing the optical fiber cable (10) using the air blowing optical fiber cable installation technique. Further, the optical fiber cable (10) comprises recesses (321, 322, 323, 324, . . . ) and protrusions (341, 342, 343, 344, . . . ) disposed alternately in a circumferential direction on an outer circumferential surface of the sheath (14).

In accordance with an embodiment of the present invention, when the optical fiber cable (10) comprises recesses (321, 322, 323, 324, . . . ) and protrusions (341, 342, 343, 344, . . . ) disposed alternately in the circumferential direction on an outer circumferential surface of the sheath (14), the optical fiber cable (10) can be installed efficiently by air blowing optical fiber cable installation technique to distances in excess of 1500 meters due to reduced weight, improved drag force and reduced contact surface area of the optical fiber cable.

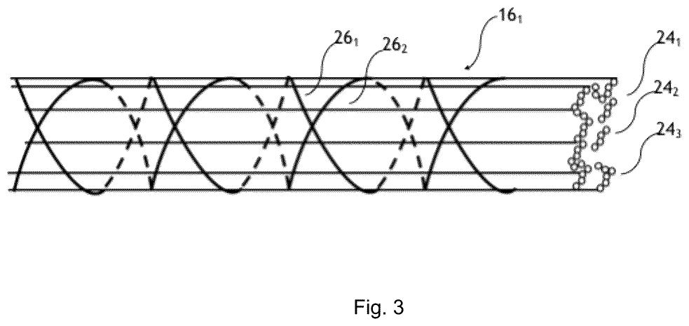

FIG. 3 is a pictorial snapshot illustrating an optical fiber bundle in accordance with an embodiment of the invention. The optical fiber bundles (16₁, 16₂, 16₃, . . . ) comprise plurality of the intermittently bonded ribbons (24₁, 24₂, 24₃, 24₄, . . . ) of optical fibers. In particular, each optical fiber bundle has plurality of the rolled optical fibers intermittently bonded ribbons and bound by one or more bundle binder (26₁, 26₂).

By way of a non-limiting example, the one or more bundle binder (26₁, 26₂) comprise a water swellable yarn. Alternatively, the one or more bundle binder (26₁, 26₂) comprise a single ended binder yarn or a dual ended binder yarn. It may be noted that a single ended binder yarn is intended to include yarn that has a single end on both sides and comprising a plurality of threads. It may be noted that a dual ended binder yarn is intended to include yarn that has two ends on both sides and each comprising a plurality of threads.

Although not shown, it can be said that the one or more core-binding elements (20₁, 20₂, 20₃, . . . ) are at least in partial contact with the optical fibers (24₁, 24₂, 24₃, 24₄, . . . ) present on the outermost surface (22) of the core (12).

Now referring back to FIG. 1, in an embodiment of the invention, there may be disposed one or more layers disposed surrounding the core, for example, there may be disposed a water blocking layer (28) a metal armor layer (not shown), a dielectric armor layer (not shown) a fire-retardant tape (not shown) surrounding the core (12). In case any of these additional layers are disposed, the core-binding element will be in at least partial contact with the additional above layer thus disposed of and will be in partial contact with the fibers in the outermost concentric layer of the bundles.

In accordance with an embodiment of the present invention, the sheath (14) may comprise one or more strengthening members (30₁, 30₂, 30₃, 30₄, . . . ) at least partially embedded within the sheath. By way of another non-limiting example, the one or more strengthening members (30₁, 30₂, 30₃, 30₄, . . . ) comprise an aramid reinforced plastic (ARP), a fiber reinforced plastic (FRP) or a metal rod such as a steel rod.

It may be noted that the optical fiber cable has a filling coefficient of greater than 60% with respect to internal diameter of the optical fiber cable. It may be noted that filling co-efficiency is ratio between sum of cross-sectional area of all optical fibers to cross sectional area of cable sheath with respect to inner diameter.

In case the filling co-efficiency is less than 60%, the cable diameter will increase.

In case the filling co-efficiency is less than 60%, the weight of the cable will increase.

Increase in cable diameter and increase in weight of the cable are not desirable in terms of carbon footprint, blowing performance, and material usage.

While several possible embodiments of the invention have been described above and illustrated in some cases, it should be interpreted and understood as to have been presented only by way of illustration and example, but not by limitation. It is believed that use of binder only around the outermost layer or outermost surface of the core ensures that there are less stresses due to binders and hence, improved optical performance. Also, the aforesaid aspect ensures high density packaging as well as reduced optical attenuations.

In an embodiment of the invention, change in attenuation of one or more optical fiber with the optical fiber cable bent at 20 times outer diameter of the optical fiber cable is less than 0.05 dB/km at a wavelength of 1550 nanometer.

In accordance with an embodiment of the present invention, three optical fiber bundles (16₁, 16₂, 16₃) may be present in an inner layer (18₁) and nine optical fiber bundles (16₄, 16₅, 16₆, 16₇, 16₈, 16₉, 16₁₀, 16₁₁, and 16₁₂) may be present in an outer layer (18₂). The outer layer (18₂) is concentric to the inner layer (18₁).

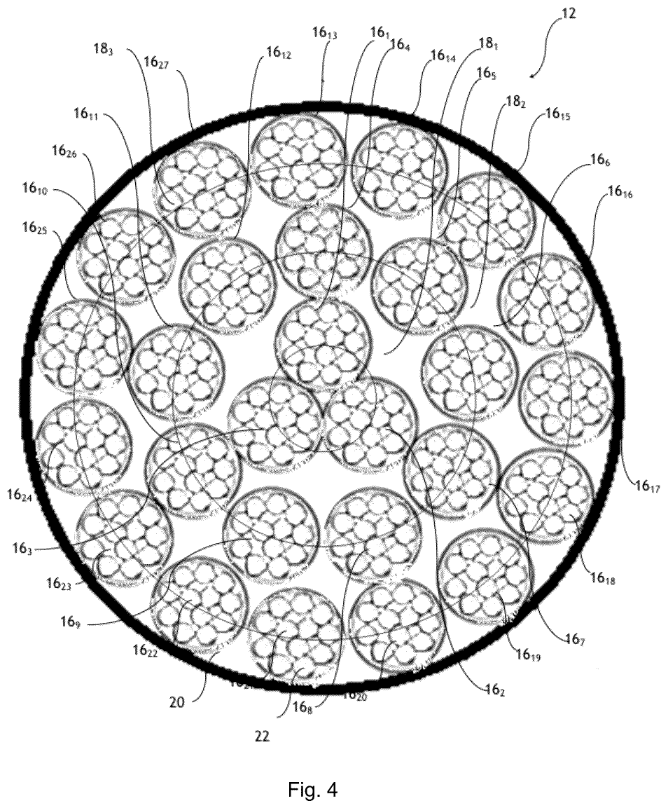

FIG. 4 is a pictorial snapshot illustrating cross-sectional of the core of the optical fiber cable constructed in accordance with another embodiment of the invention. Particularly, in an alternative embodiment, the optical fiber bundles (161, 162, 163, . . . ) may be arranged in three concentric layers namely, an inner layer (181), an outer layer (182) and an intermediate layer (183). The intermediate layer (183) is positioned between the inner layer (181) and the outer layer (182). By way of non-limiting examples, three optical fiber bundles (161, 162, 163) may be present in the inner layer (181); nine optical fiber bundles (164, 165, 166, 167, 168, 169, 1610, 1611, and 1612) may be present in the intermediate layer (183); and fifteen optical fiber bundles (1613, . . . , 1627) may be present in the outer layer (182).

In different embodiments, the one or more core-binding elements is applied only on the outermost bundle layer (182).

In accordance with an embodiment of the present invention, a method of manufacturing an optical fiber cable comprising: providing a core comprising a plurality of optical fiber bundles present in at least two concentric layers, helically applying one or more core-binding elements only on an outermost surface of the core so as to hold the plurality of optical fiber bundles and extruding a sheath so as to surround the core having the one or more core-binding elements applied thereto.

In accordance with an embodiment of the present invention, the plurality of optical fiber bundles present in at least two concentric layers are twisted (or stranded) simultaneously and bound using two core-binding elements in opposite directions only on the outer layer of the core. Thus, there is no binder present around the inner layer.

Advantageously, the optical fiber cable has a filling co-efficiency of greater than 60% with respect to the internal diameter of the optical fiber cable. The optical fiber cable has reduced weight because of the absence of a binding element to bind the plurality of optical fiber bundles in at least one inner layer of the at least two concentric layers. Further, the optical fiber cable has reduced cost because of the absence of binding element to bind the plurality of optical fiber bundles in at least one inner layer of the at least two concentric layers.

The optical fiber cable has reduced optical attenuations because of absence of binding element to bind the plurality of optical fiber bundles in at least one inner layer of the at least two concentric layers. Further, a level of mismatch in lay length of the plurality of optical fiber bundles in at least one inner layer of the at least two concentric layers and a lay length of the plurality of optical fiber bundles in the outermost layer of the at least two concentric layers is substantially low. Thus, a level of attenuation is substantially less and hence, a level of degradation optical properties of the fiber is substantially less.

Additionally, the optical fiber cable can be installed efficiently by air blowing optical fiber cable installation technique to a distance in excess of 1500 meters due to reduced weight of the optical fiber cable. Thereby time of manufacturing the optical fiber cable can be substantially reduced because of absence of binding element to bind the plurality of optical fiber bundles in at least one inner layer of the at least two concentric layers.

Another advantage of the invention is that the time of manufacturing the optical fiber cable can be substantially reduced because of the absence of a binding element to bind the plurality of optical fiber bundles in at least one inner layer of the at least two concentric layers.

Furthermore, the process of manufacturing the optical fiber cable becomes simplified as the invention does away with binding the plurality of optical fiber bundles in at least one inner layer of the at least two concentric layers using a binding element.

A person of ordinary skill in the art may be aware that, in combination with the examples described in the embodiments disclosed in this specification, units and algorithm steps may be implemented by electronic hardware, computer software, or a combination thereof.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

In a case that no conflict occurs, the embodiments in the present invention and the features in the embodiments may be mutually combined. The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. An optical fiber cable (10) comprising
a core (12); and
a sheath (14) surrounding the core (12);
wherein the core (12) comprising a plurality of optical fiber bundles (16₁, 16₂, 16₃, . . . ) present in at least two concentric layers (18₁, 18₂, . . . ); and
wherein the plurality of optical fiber bundles (16₁, 16₂, 16₃, . . . ) are held together by one or more core-binding elements (20₁, 20₂, . . . ) applied only on an outermost surface (22) of the core (12).

2. The optical fiber cable as claimed in claim 1, wherein the one or more core-binding elements (20₁, 20₂, . . . ) are helically applied only on the outermost surface (22) of the core (12).

3. The optical fiber cable as claimed in claim 1, wherein the core-binding elements (20₁, 20₂, . . . ) comprise a water swellable yarn.

4. The optical fiber cable as claimed in claim 1, wherein the core-binding elements (20₁, 20₂, . . . ) comprise a single ended binder yarn or a dual ended binder yarn.

5. The optical fiber cable as claimed in claim 1, wherein the optical fiber bundles (16₁, 16₂, 16₃, . . . ) in each of the at least two concentric layers (18₁, 18₂, . . . ) binding are twisted in a first direction (D1) and then in second direction (D2) opposite to the first direction (D1) with substantially same lay length.

6. The optical fiber cable as claimed in claim 5, wherein a ratio of lay length (L1) of the core (12) and diameter of the core is in the range of 25 to 100.

7. The optical fiber cable as claimed in claim 5, wherein a ratio of lay length (L1) of the core (12) and lay length (L2) of the at least one core-binding elements (20₁, 20₂, . . . ) is in the range of 4 to 12.

8. The optical fiber cable as claimed in claim 1, wherein the at least two concentric layers (18₁, 18₂, . . . ) are twisted so as to be substantially in-phase with each other.

9. The optical fiber cable as claimed in claim 1, wherein the optical fiber bundle (16₁, 16₂, 16₃, . . . ) comprises plurality of rolled intermittently bonded optical fibers ribbons.

10. The optical fiber cable as claimed in claim 1, wherein each of the one or more optical fiber bundles (16₁, 16₂, 16₃, . . . ) in the at least two concentric layers (18₁, 18₂, . . . ) is bound by one or more bundle binder yarns (26₁, . . . 26ₙ).

11. The optical fiber cable as claimed in claim 1, wherein a change in attenuation of one or more optical fiber (24₁, . . . 24ₙ) with the optical fiber cable (10) bent at 20 times outer diameter of the optical fiber cable (10) is less than 0.05 dB/km measured at 1550 nanometer wavelength.

12. The optical fiber cable as claimed in claim 1, wherein the optical fiber cable (10) has a filling co-efficiency of greater than 60% with respect to internal diameter of the optical fiber cable (10).

13. The optical fiber cable as claimed in claim 1, wherein the sheath (14) comprises one or more at least partially embedded strengthening members (30₁, 30₂, 30₃, 30₄, . . . ).

14. The optical fiber cable as claimed in claim 1, wherein the optical fiber cable (10) comprises recesses (32₁, 32₂, 32₃, 32₄, . . . ) and protrusions (34₁, 34₂, 34₃, 34₄, . . . ) disposed alternately in a circumferential direction on an outer circumferential surface of the sheath (14).

15. The optical fiber cable as claimed in claim 1, wherein one of:
the plurality of optical fiber bundles (16₁, 16₂, 16₃ . . . ) are arranged in two concentric layers comprising an inner layer (18₁) and an outer layer (18₂); or
the plurality of optical fiber bundles (16₁, 16₂, 16₃ . . . ) are arranged in three concentric layers comprising an inner layer (18₁), an outer layer (18₂) and an intermediate layer (183) positioned between the inner layer (18₁) and the outer layer (18₂).

16. The optical fiber cable as claimed in claim 1, wherein the one or more core-binding elements (20₁, 20₂, . . . ) is at least in partial contact with the one or more optical fiber (24₁, . . . 24n).

17. A method of manufacturing an optical fiber cable, said method comprising:
providing a core (12) comprising a plurality of optical fiber bundles (16₁, 16₂, 16₃, . . . ) present in at least two concentric layers (18₁, 18₂, . . . );
helically applying one or more core-binding elements (20₁, 20₂, . . . ) only on an outermost surface (22) of the core (12) so as to hold the plurality of optical fiber bundles (16₁, 16₂, 16₃, . . . ); and
extruding a sheath (14) so as to surround the core (12) having the one or more core-binding elements (20₁, 20₂, . . . ) applied thereto.

18. The method as claimed in claim 17, wherein the plurality of optical fiber bundles (16₁, 16₂, 16₃, . . . ) present in at least two concentric layers (18₁, 18₂, . . . ) are twisted simultaneously.

19. The method as claimed in claim 17, wherein the plurality of optical fiber bundles (16₁, 16₂, 16₃, . . . ) present in at least two concentric layers (18₁, 18₂, . . . ) are bound using two core-binding elements (20₁, 20₂, . . . ) in opposite directions only on the outermost surface (22) of the core (12).

20. The method as claimed in claim 19, wherein the optical fiber bundles (16₁, 16₂, 16₃, . . . ) in each of the at least two concentric layers (18₁, 18₂, . . . ) binding are twisted in a first direction (D1) and then in second direction (D2) opposite to the first direction (D1) with substantially same lay length.
